(19) United States
(12) Patent Application Publication
(10) Pub. No.: US 2026/0127346 A1
(43) Pub. Date: May 7, 2026

(54) SYSTEMS AND METHODS FOR CALIBRATING SEMICONDUCTOR PROCESS EMULATION MODELS

(71) Applicant: Intel Corporation, Santa Clara, CA (US)

(72) Inventors: Santosh Tripathi, Portland, OR (US); Timothy Crimmins, Portland, OR (US)

(73) Assignee: Intel Corporation, Santa Clara, CA (US)

(21) Appl. No.: 18/940,702

(22) Filed: Nov. 7, 2024

(51) Int. Cl. G06F 30/331; G06F 119/02

(52) U.S. Cl. CPC G06F 30/331; G06F 2119/02

(57) ABSTRACT

Systems and methods for automated calibration of semiconductor process emulation models. The method includes accessing process data for a foundry process node and process node revision, wherein the process data includes a plurality of process parameters. The processor-implemented method receives target feature(s) and generates predicted output which are cross-sectional images of the target feature(s), based on the value of the semiconductor process emulation model parameters. The method compares the predicted output to actual measurements of the target feature(s) obtained from characterization data. The method automatically calibrates the process emulation model by varying the values of model parameters (the input to the semiconductor process models) and generating respective predicted output. The method evaluates the predicted output based on a supplied error criteria and error value. The method iterates until the determined error is less than or equal to a supplied error value.

### BACKGROUND

To enable a semiconductor manufacturing process to have a high yield of high-performance devices, the three-dimensional semiconductor device structure and structural variability achieved by the semiconductor manufacturing process must be well-characterized and understood. Semiconductor process emulation models are often at least a part of this characterization process. Continued improvements to these semiconductor process emulation models are desirable.

### BRIEF DESCRIPTION OF THE DRAWINGS

FIG. 1 is a block diagram depicting an example environment in which embodiments may operate.

FIG. 2 provides a non-limiting example of architectural block diagram of one or more application modules that may be operating in the system for calibrating semiconductor process emulation models, in accordance with various embodiments.

FIG. 3 illustrates an exemplary method for calibrating semiconductor process emulation models, in accordance with various embodiments.

FIG. 4 is a top view of a wafer and dies that may have been fabricated and characterized, in accordance with any of the embodiments disclosed herein.

FIG. 5 is a simplified cross-sectional side view showing an implementation of an integrated circuit on a die that may include various features that may be target features, in accordance with any of the embodiments disclosed herein.

FIG. 6 is a cross-sectional side view of a microelectronic assembly that may be constructed pursuant to any of the embodiments disclosed herein.

FIG. 7 illustrates an exemplary compute node, on which embodiments may operate.

### DETAILED DESCRIPTION

To enable a semiconductor manufacturing process to have a high yield of high-performance devices, the three-dimensional semiconductor device structure and structural variability achieved by the semiconductor manufacturing process must be well-characterized and understood. Properly characterizing a library for a target foundry process and version/release is technically challenging. Semiconductor process emulation is often at least a part of this characterization process.

Target features are referred to herein. Target features may be part of a standard cell. As is understood by those with skill in the art, a standard cell is a function in digital logic; it can be a simple function, like an inverter, or a more complex gate or sequential element. A plurality of standard cells, embodied as intellectual property (IP) cores, which are reusable units of logic and/or layout for standard cells, is sometimes referred to as a library. The libraries include geometries and margins, for example, the length, width, and thickness of a metal trace or gate, and its margin, such as +/−20%.

Semiconductor process emulation takes fabrication process information and parameters and predicts wafer output (and how those standard cells and target features appear) based thereon. Available standard characterization methods generally rely on running silicon experiments and then collecting transmission electron microscopy (TEM), E-Test, optical critical dimension (OCD), and other data. After collecting the data, the data is stored and models used for emulating the semiconductor process are manually revised. Additionally, the fabrication process/version can have inherent issues that are not discovered until the product is fabricated and tested, such as, during failure analysis. A product may not be functional or may have a low yield using a given library because of a standard cell defect that occurs because of a manufacturing fabrication issue rather than due to a faulty design. In combination, available methods for calibrating semiconductor process emulation models are technically challenging and have a turn-around time of weeks to months, which is a disadvantage.

Embodiments provide a technical solution to these technical problems and other related enhancements, in the form of systems and methods for calibrating semiconductor process emulation models. Embodiments automatically calibrate semiconductor process emulation models so that the predictions from ‘Semiconductor Process Emulation’ matches with what is physically observed when wafers are physically processed using that semiconductor process for wafer fabrication. Some embodiments implement machine learning (ML) or artificial intelligence (AI) to perform some of the processing described herein. Provided embodiments introduce a predictive self-calibrating method to reduce this turnaround time, increasing process yield and performance ramps.

Aspects of this disclosure can be detected with a visual inspection of release notes from third-party suppliers of libraries, the release notes would accompany a process node and/or process node revision release. If the release notes reference or supply cross sectional device images that are not direct from physical sectioning, this can indicate the presence of the herein disclosed embodiments. A more detailed description of the aspects of the present disclosure follows a terminology section.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Example embodiments are hereinafter described in conjunction with the following drawing figures, wherein like numerals denote like elements. Figures are not necessarily to scale. For the sake of brevity, well-known structures and devices may be shown in block diagram form to facilitate a description thereof.

Embodiments of systems for calibration of semiconductor process emulation models may be implemented in a variety of systems, apparatus, consumer products, such as electronic design automation (EDA) tools, computer aided design (CAD) tools, computing devices, and the like. Additionally, embodiments of systems for calibration of semiconductor process emulation models can be found in machine-readable storage media having machine-readable instructions that when executed cause one or more processor to perform a method as described herein.

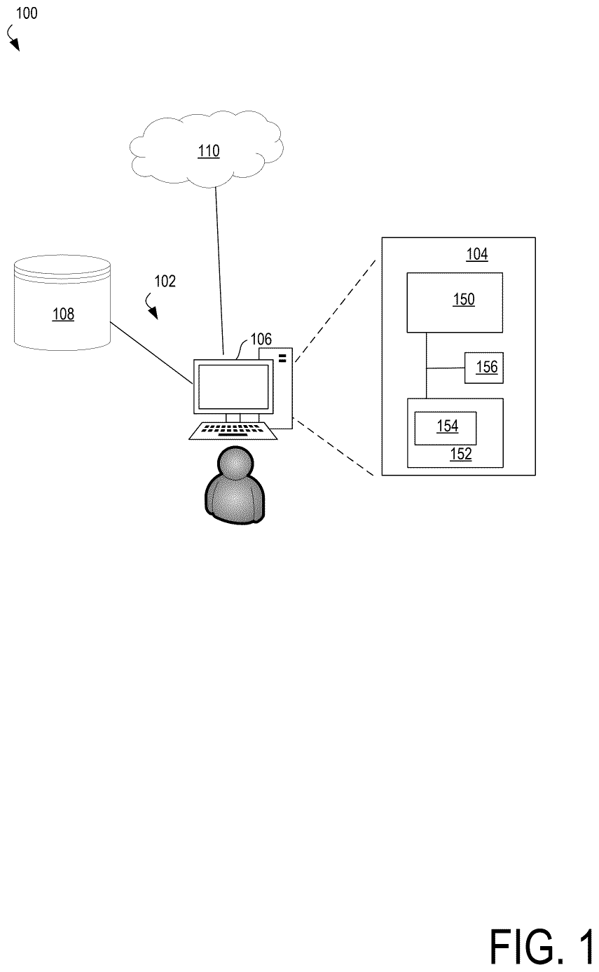

FIG. 1 illustrates an exemplary environment 100 in which embodiments may operate. The system for calibration of semiconductor process emulation models (shortened herein to system 102) may operate on a compute device 106 and be in wire or wireless communication with one or more database(s) 108, and in wireless communication with the cloud 110. The system 102 includes a control module.

As used herein, the term “module” may refer to any hardware, software, firmware, electronic control component, processing logic, and/or processor device, individually or in any combination. In various embodiments, a module is one or more of: an application specific integrated circuit (ASIC), a field-programmable gate-array (FPGA), an electronic circuit, a computer system comprising a processor (shared, dedicated, or group) and memory that executes one or more software or firmware programs, a combinational logic circuit, and/or other suitable components that provide the functionality attributed to the module. In various embodiments, a software program in a module encodes an algorithm or procedure of rules for the processor to execute. In various embodiments, all or part of the functionality of the control module can be performed by a machine learning model (ML), neural net (NN) or other variation of artificial intelligence.

In FIG. 1, the control module is embodied as a control circuit 104. In various embodiments, the control circuit 104 is realized as an enhanced computer system, comprising a computer readable storage device or media, memory 152, for storage of instructions, algorithms, and/or programs, such as vehicle-target localization algorithm and a plurality of preprogrammed thresholds and parameters, the processor 150 to execute the program 154, and input/output interface (I/O) 156. The computer readable storage device or media, memory 152, may include volatile and nonvolatile storage in read-only memory (ROM), random-access memory (RAM), and keep-alive memory (KAM), for example. KAM is a persistent or non-volatile memory that may be used to store various operating variables while the processor 150 is powered down. The memory 152 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the processor 150 in controlling the system 102. In various embodiments, processor 150 is configured to implement the system 102. The memory 152 may also be utilized by the processor 150 to cache data, to temporarily store results of comparisons and analyses, and the like. Information in the memory 152 may be organized and/or imported from an external source during an initialization or installment operation in a method; it may also be programmed via a user I/O interface.

The input/output interface (I/O) 156 may be operationally coupled to the processor 150 via a bus and enables intra-control circuit 104 communication as well as extra-control circuit 104 communication. The input/output interface (I/O) 156 may include one or more wired and/or wireless network interfaces and can be implemented using any suitable method and apparatus. In various embodiments, the input/output interface (I/O) 156 includes the hardware and software to support one or more communication protocols for wireless communication between the processor 150 and external sources, such as satellites, the cloud, communication towers and ground stations. In various embodiments, the input/output interface (I/O) 156 supports communication with technicians, and/or one or more storage interfaces for direct connection to storage apparatuses.

During operation of the system 102, the processor 150 loads and executes one or more algorithms, instructions, and rules embodied as program 154, and, as such, controls the general operation of the system 102. During operation of the system 102, the processor 150 may receive data from external sources (such as WiFi signal(s), the cloud 110, or other systems configured to operate within the computing device 106). In various embodiments of the system 102, the control circuit 104 may: perform operations attributed to the system 102 in accordance with an algorithm; perform operations in accordance with state machine logic; and perform operations in accordance with logic in a programmable logic array.

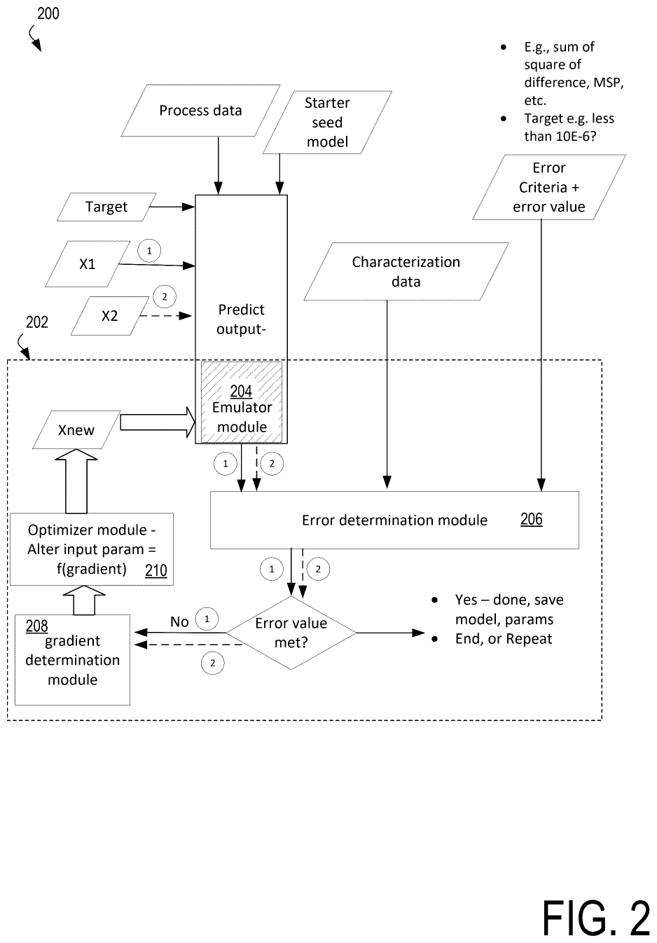

While the exemplary embodiment of the system 102 is described in the context of the control circuit 104 implemented as a fully functioning enhanced computer system, those skilled in the art will recognize that the mechanisms of the present disclosure are capable of being distributed as a program product including program 154 and predefined parameters. Such a program product may comprise an arrangement of instructions organized as multiple interdependent program code modules (see, e.g., FIG. 2, modules in system 202), each configured to achieve a separate process and/or perform a separate algorithmic operation, arranged to manage data flow through the system 102. The program code modules may each comprise an ordered listing of executable instructions for implementing logical functions for the processes performed by the system 102. The instructions in the program code modules, when executed by a processor (e.g., processor 150), cause the processor to receive and process signals, and perform logic, calculations, methods and/or algorithms as described herein for automatically and in real-time performing vehicle-target localization and generating associated commands.

Once developed, the program code modules constituting a program product may be stored and distributed individually, or together, using one or more types of non-transitory computer-readable signal bearing media may be used to store and distribute the instructions, such as a non-transitory computer readable medium. Such a program product may take a variety of forms, and the present disclosure applies equally regardless of the type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized as memory and as program product time-based viewing of clearance requests in certain embodiments. Moreover, Once developed, the program code modules may be integrated into another superseding program product.

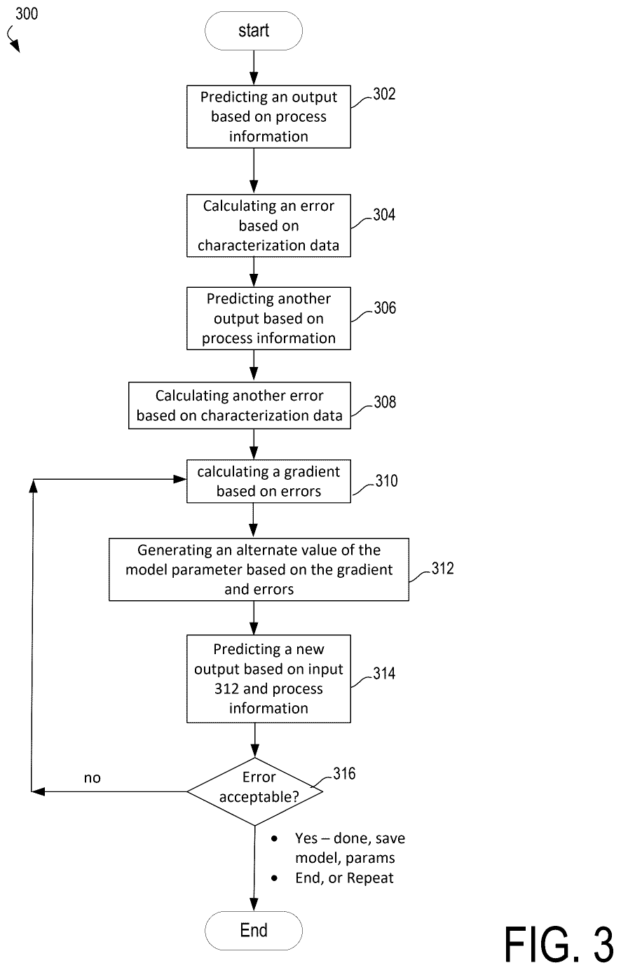

FIG. 2 and FIG. 3 can be referenced together. FIG. 2 provides a non-limiting example embodiment 200 of the system 102 showing an architectural block diagram of one or more application modules (e.g., the aforementioned interdependent program code modules) that may be operating in the system 102. The modules in FIG. 2 are referenced in conjunction with FIG. 3, which illustrates operations of a method 300 for calibration of a semiconductor process emulation model. It is to be understood that FIG. 2 and FIG. 3 provide a simple example to develop concepts, and that in practice, the model may have many more inputs and outputs, concurrently.

As illustrated in embodiment 200, inputs into the system 202 can include first value of model parameters X1, second value of model parameters X2, target i.e. desired output, process data, a manually generated starter seed semiconductor process emulation model, characterization data, a cost function and a cost function target. Some of these inputs, such as, the process data, the characterization data, and sometimes also a library of standard cells may come from a database. With reference back to FIG. 1, in practice, the database 108 may be physically embodied as multiple different data storage devices, or areas in memory, and may include at least the process data and the characterization data.

Before proceeding, some terminology is defined:

As used herein, “process data/process information” is an input that reflects a process node and/or process node revision, specifying operations to perform on a wafer, and includes a plurality of process parameters, such as temperatures, rates of flow, types of chemicals and materials used. Process information is analogous to a recipe. A semiconductor process can include or be part of other sub-processes, such as deposition, printing, annealing, etching, polishing; each having their own sequence and recipe. Process information may inform how edges are shaped (substantially straight, or tapered), thicknesses, and the like. This process data input can also include constraints, or ranges, to allow an individual parameter to range by, such as between 1 Angstrom and 2 Angstroms, inclusive of endpoints.

As used herein, a “model parameter” (e.g., X, Y) is a parameter input to the semiconductor process emulation model that embodiments of the system 102/202 can, and may, alter during operation (e.g., X1, X2, and Xnew). A non-limiting example of a model parameter is a temperature. In a simple example, X1 is a first temperature input to the emulator module, X2 is a second temperature input into the emulator module 204, and Xnew is an altered temperature, created as a function of a slope by the optimizer module 210 (described in more detail below). While a simple example is described below, using just one input parameter (e.g., temperature), those with skill in the art will appreciate that, in practice, embodiments may change multiple input parameters concurrently.

As used herein, a “target” is a desired output or result, generally, a post-processing target feature or parameter, and may include the measurement of the target feature. A non-limiting example of a target is the thickness of a silicon nitride layer, or “a layer of silicon nitride with thickness [x].” In some embodiments, there may be multiple targets supplied to the system 102/202 concurrently.

As used herein, “predicted output” is the output from the semiconductor process emulator module 204, it is a predicted value based on the target, at least one input parameter (e.g., X1) and the process data. In some embodiments, predicted output includes cross-sectional images. In other embodiments, predicted output consists of only cross-sectional images. Returning to the above example, if the target is a thickness of 10 microns, and the at least one input parameter X1 is 70 degrees, an example predicted output as a function of the process data might be 6 microns.

As used herein, “characterization data” refers to the collection of actual results or output, and includes direct measurements of features in devices, made on the wafer post-processing, to represent what happened to the wafer from the processing. Characterization data may include, but not be limited to, transmission electron microscope (TEM) images for cross-sectional images and scanning electron microscope imagining (SEM) for planar or top-down images. In some embodiments, characterization data may include optical critical dimension (OCD), TOF-SIMS, and other relevant types of physical data and measurements.

This information may describe features such as gates, drains, sources, contacts, metal traces, etc., from a standard cell library. Characterization data can embody, for devices and features, measurements taken from one or more locations around a wafer, and taken from one or more wafers fabricated by a semiconductor process that implements one or more process steps.

As used herein, “cost function and/or error criteria” is a rule to evaluate how close the predicted output is to the actual data from the characterization data and is expressed as a difference between the physically observed cross-sections (characterized) and the cross-sections predicted by the semiconductor process emulation model 204. The predicted output cross-section may be pixelated, and the characterization data cross-section may be pixelated to enable pixel by pixel comparisons to identify differences.

In some embodiments, the cost function difference is defined as the difference in profile of a structure in the physical (characterized) cross-section and a respective emulated or predicted (computational) cross-section. In some embodiments, the difference in profile is weighted by a curvature of the profile.

In some embodiments, the cost functions are calculated as the sum of a square of the difference. In other embodiments, the cost function is calculated as material-sin-product (MSP) where MSP is calculated as count of pixels in the characterized vs. the predicted feature and they may further include a different material, after registration, between the two types of cross-sections. Additionally, in some embodiments, the MSP is further weighted by a curvature of the material around the respective pixel.

As used herein, “cost function target, or CF target” is a number representing an acceptable limit of error. Plainly, this means how much of a difference between the predicted and actual can be tolerated, and it is a programmable number. In the first non-limiting example, the CF target is 10E-3, in a second non-limiting example, the CF target is 10E-6, and etc. In some embodiments, the system 102/202 may accept multiple CF targets concurrently, wherein an individual CF target of the multiple CF targets is applied to a respective cost function.

The starter seed model is a human-created model. A starter seed model may be implemented by a processor architecture and, in various embodiments, may include or be integrated with a machine-learning model, an untrained convergent neural net, or the like. It can be rudimentary, as once it is implemented, the system 202 is self-calibrating and continues to improve the model. The reduced pressure from not needing to provide a perfected model advantageously saves an enormous amount of time. As the model is improved, the predictive capabilities (i.e., the quality of the predicted output, as measurable by decreased differences) improve. This self-calibrating aspect is one of many advantages provided by embodiments and is described in more detail below.

At 302, the system 202 (e.g., in the emulator module 204) accesses a semiconductor process emulation model and predicts an output based on the process data, starter seed model, the target, and an input parameter X1 (e.g., a first input parameter).

At 304, the system 202 (e.g., by the error determination module 206) determines an error based on the characterization data, by comparing the predicted output (1) to the actual data. As detailed above, the error determination may be performed in a variety of ways, and in any given embodiment, it is based on a received cost function.

The error determination is a comparison of a predicted output from the emulator module 204 (generally, with respect to a target feature), and an actual measurement of the same target feature taken from characterization data. The system 102/202 self-calibrates until the error between these two vary by less than or equal to the acceptable error, or error value. In other embodiments, the emulator module 204 may be embodied as a means for emulation, and the error determination module 206 may be embodied as an error determination means.

In a non-limiting example, the error determination module 206 may determine a curvature of a profile of the target feature in the final predicted output, and also determine the curvature of a profile of the target feature in the actual data (i.e., the characterization data). The error determination module 206 may calculate the respective measurements by weighting the cost function based on the respective curvatures of the profiles.

Also, as mentioned above, at 304 (and at 308, and post-314) the system 102/202 or the error determination module 206 may pixelate the source of the actual measurement (e.g., a TEM image) to create a pixelated actual image; and pixelate the predicted output to create a pixelated predicted image. In scenarios in which the cost function is a material-sin-product (MSP), calculating the MSP to determine an error may include a count of pixels.

For example, the system 202 may identify a first material near the target feature in the pixelated predicted image and identify a second material near the target feature in the pixelated actual image; and the final measurement is a function of a number of pixels for which the first material and the second material are not equal.

Embodiments take as an input a constraint of a maximum allowable error (the error value or CF target). At a decision point, the system 202 determines whether the error (1) is within the CF target (for example, less than or equal to the allowable error). If it is, then the model does not need further self-calibration, the “final predicted output” has been generated, the model and the parameters, including the one or more alternate parameters, can be saved, and the method 300 may end.

In the case that the CF target is not met (i.e., the measurement difference is greater than the acceptable error or CF target) for the first input parameter (path 1), the method 300 proceeds, and embodiments can change the value of the first input parameter, generating Xnew, in as many iterations as needed. Further, embodiments can switch to a different model parameter (e.g., Y) and again keep self-calibrating, i.e., keep generating predicted output until the predicted output is within the constraint or allowable error (CF target) from the actual output. During this calibration process, the predicted cross-sectional images are referred to as “intermediate” to distinguish them as being generated during calibration instead of when calibration is finished. Continuing with the example, at 306 the system 202 receives at least another (e.g., a second) input parameter X2 and (e.g., by the emulator module 204) predicts an output based on the process data, starter seed model, target feature, and X2.

At 308, the system 202 (e.g., by the error determination module 206) determines another error based on the characterization data, by comparing the predicted output (2) to the actual data, as described herein.

At the decision point, the system 202 determines whether the error (2) is within the CF target. If it is (e.g., the measurement difference is less than or equal to the CF target), then the processor-implemented model does not need further self-calibration, it is considered trained or calibrated, and the model and the parameters can be saved, and the method 300 may end.

At 310, the system 202 determined that neither error (1) nor error (2) met the CF target and proceeds to the gradient determination module 208. The gradient determination module 208 compares at least two errors generated, e.g., error (1) or error (2), and calculates a gradient as compared to the errors themselves. In other embodiments, the gradient may be calculated as an enumerative search, a parameter continuation, a trajectory search, using relaxation methods, using branch-and-bound methodology, using a random search, using a Bayesian search, using an adaptive stochastic search, using an evolutionary method, via simulated annealing, using a tabu search, and etc.

The model in the system 202 compares (e.g., by the optimizer module 210) the calculated gradient to the input parameters and target to generate therefrom an altered value for a model parameter (Xnew). Because the error(s) are between actual and predicted values, by calculating two or more errors, the embodiments can calculate a gradient. Comparing the errors and the gradient to previous gradients enables determining when the error is increasing/decreasing at a faster or slower rate, and based on this, embodiments determine how much to change a parameter on the next iteration.

At 312, the system 202 generates an alternate value of a model parameter based on the gradient and the previous errors. The altered input parameter Xnew is a function of the gradient, and represents one round of self-calibration, for one model parameter, X (wherein X collectively represents X1, X2, and Xnew). Xnew is supplied as an input to the system 202 at 314 and the system predicts a new output based on the Xnew input and process information.

The system 202 calculates an error at 316, as described for 304 and 308, and the system 202 determines at a decision 316 whether the error is acceptable (e.g., the CF is met). If, at 316, the response is “NO,” the system 202 cycles back to 310 and continues the self-calibration of the model as described above. When the response at 316 is “YES,” the model is satisfactorily calibrated and may be saved/stored, along with respective parameter values.

Worth mentioning again is that this simplified example (using just one model parameter, X) is used to describe the self-calibration and predictive capabilities of the model implemented in this system and method. In practice, the example model parameter X is one of a plurality of model parameters and the system may concurrently generate alternate values for every model parameter of the plurality of the model parameters, thereby creating a vector; the system 102/202 may then, in each iteration, apply the created vector of alternate values to the semiconductor process emulation model to generate therefrom a predicted output; moreover, there may be hundreds or thousands of targets supplied to the embodiment 200. Additionally, embodiments can flexibly receive updated or different process data; running the system 202 (after it has automatically or self-calibrated on a first set of process data) using a second set of process data, letting it perform its self-calibrating feature using the new process data is an anticipated use of embodiments.

The use of the characterization data from the fabrication process by embodiments provides several advantages, not limited to the use of cross-sectional images in the semiconductor process emulator; and the ability to begin with a rudimentary seed model, eliminating days and weeks of human manipulation of the model used in the semiconductor process emulator.

Thus, systems and methods for calibrating semiconductor process emulation models have been provided. The following description illustrates various context for usage and application of provided aspects of the present disclosure.

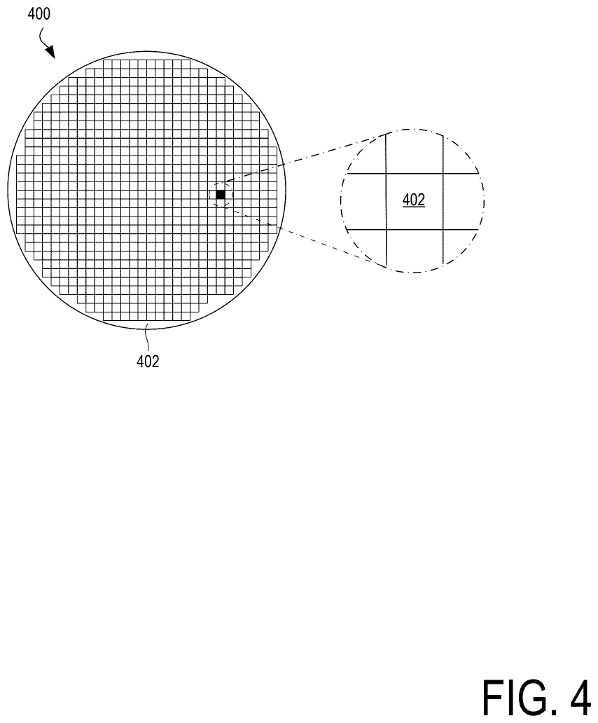

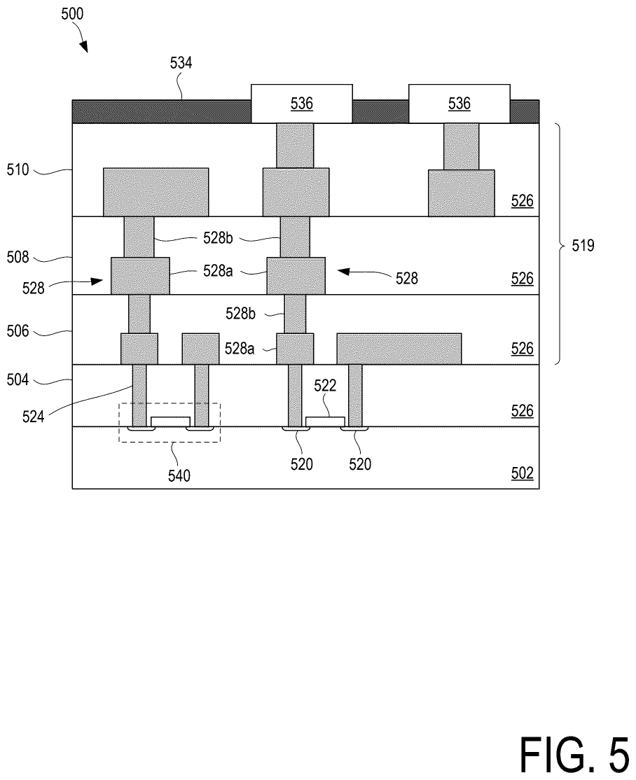

FIG. 4 is a top view of a wafer 400 and dies 402 that may include any of the embodiments disclosed herein. The wafer 400 may be composed of semiconductor material and may include one or more dies 402 formed on a surface of the wafer 400. After the fabrication of the integrated circuit components on the wafer 400 is complete, the wafer 400 may undergo a singulation process in which the dies 402 are separated from one another to provide discrete “chips” or destined for a packaged integrated circuit component. The individual dies 402, comprising an integrated circuit component, may include one or more transistors (e.g., some of the transistors 540 of FIG. 5, discussed below), supporting circuitry to route electrical signals to the transistors, passive components (e.g., signal traces, resistors, capacitors, or inductors), and/or any other integrated circuit components. In some embodiments, the wafer 400 or the die 402 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Additionally, multiple devices may be combined on a single die 402. For example, a memory array formed by multiple memory devices may be formed on a same die 402 as a processor unit or other logic that is configured to store information in the memory devices or execute instructions stored in the memory array. In some embodiments, a die 402 may be attached to a wafer 400 that includes other die, and the wafer 400 is subsequently singulated, this manufacturing procedure is referred to as a die-to-wafer assembly technique.

FIG. 5 is a cross-sectional side view of an integrated circuit 500 that may be included in any of the embodiments disclosed herein. One or more of the integrated circuits 500 may be included in one or more dies 402 (FIG. 4). The integrated circuit 500 may be formed on a die substrate 502 (e.g., the wafer 400 of FIG. 4) and may be included in a die (e.g., the die 402 of FIG. 4).

The die substrate 502 may be a semiconductor substrate composed of semiconductor material systems including, for example, n-type or p-type materials systems (or a combination of both). The die substrate 502 may include, for example, a crystalline substrate formed using a bulk silicon or a silicon-on-insulator (SOI) substructure. In some embodiments, the die substrate 502 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 502. Although a few examples of materials from which the die substrate 502 may be formed are described here, any material that may serve as a foundation for an integrated circuit 500 may be used. The die substrate 502 may be part of a singulated die (e.g., the dies 402 of FIG. 4) or a wafer (e.g., the wafer 400 of FIG. 4).

The integrated circuit 500 may include one or more device layers 504 disposed on the die substrate 502. The device layer 504 may include features of one or more transistors 540 (e.g., metal oxide semiconductor field-effect transistors (MOSFETs)) formed on the die substrate 502. The transistors 540 may include, for example, one or more source and/or drain (S/D) regions 520, a gate 522 to control current flow between the S/D regions 520, and one or more S/D contacts 524 to route electrical signals to/from the S/D regions 520.

The gate 522 may be formed of at least two layers, a gate dielectric, and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be conducted on the gate dielectric to improve its quality when a high-k material is used.

The gate electrode may be formed on the gate dielectric and may include at least one p-type work function metal or n-type work function metal, depending on whether the transistor 540 is to be a p-type metal oxide semiconductor (PMOS) or an n-type metal oxide semiconductor (NMOS) transistor. In some implementations, the gate electrode may comprise a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 540 along the source-channel-drain direction, the gate electrode may comprise a U-shaped structure that includes a bottom portion substantially parallel to the surface of the die substrate 502 and two sidewall portions that are substantially perpendicular to the top surface of the die substrate 502. In other embodiments, at least one of the metal layers that form the gate electrode may simply be a planar layer that is substantially parallel to the top surface of the die substrate 502 and does not include sidewall portions substantially perpendicular to the top surface of the die substrate 502. In other embodiments, the gate electrode may comprise a combination of U-shaped structures and planar, non-U-shaped structures. For example, the gate electrode may comprise one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and include deposition and etching processes. In some embodiments, a plurality of spacer pairs may be used; for instance, two pairs, three pairs, or four pairs of sidewall spacers may be formed on opposing sides of the gate stack.

The S/D regions 520 may be formed within the die substrate 502 adjacent to the gate 522 of individual transistors 540. The S/D regions 520 may be formed using an implantation/diffusion process or an etching/deposition process, for example. In the former process, dopants such as boron, aluminum, antimony, phosphorous, or arsenic may be ion-implanted into the die substrate 502 to form the S/D regions 520. An annealing process that activates the dopants and causes them to diffuse farther into the die substrate 502 may follow the ion-implantation process. In the latter process, the die substrate 502 may first be etched to form recesses at the locations of the S/D regions 520. An epitaxial deposition process may then be conducted to fill the recesses with material that is used to fabricate the S/D regions 520. In some implementations, the S/D regions 520 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 520 may be formed using one or more alternate semiconductor materials such as germanium or a group III-V material or alloy. In further embodiments, one or more layers of metal and/or metal alloys may be used to form the S/D regions 520.

Electrical signals, such as power and/or input/output (I/O) signals, may be routed to and/or from the devices (e.g., transistors 540) of the device layer 504 through one or more interconnect layers disposed on the device layer 504 (illustrated in FIG. 5 as interconnect layers 506-510). For example, electrically conductive features of the device layer 504 (e.g., the gate 522 and the S/D contacts 524) may be electrically coupled with the interconnect structures 528 of the interconnect layers 506-510. The one or more interconnect layers 506-510 may form a metallization stack (also referred to as an “ILD stack”) 519 of the integrated circuit 500.

The interconnect structures 528 may be arranged within the interconnect layers 506-510 to route electrical signals according to a wide variety of designs; in particular, the arrangement is not limited to the particular configuration of interconnect structures 528 depicted in FIG. 5. Although a particular number of interconnect layers 506-510 is depicted in FIG. 5, embodiments of the present disclosure include integrated circuits having more or fewer interconnect layers than depicted.

In some embodiments, the interconnect structures 528 may include lines 528a and/or vias 528b filled with an electrically conductive material such as a metal. The lines 528a may be arranged to route electrical signals in a direction of a plane that is substantially parallel with a surface of the die substrate 502 upon which the device layer 504 is formed. For example, the lines 528a may route electrical signals in a direction in and out of the page and/or in a direction across the page. The vias 528b may be arranged to route electrical signals in a direction of a plane that is substantially perpendicular to the surface of the die substrate 502 upon which the device layer 504 is formed. In some embodiments, the vias 528b may electrically couple lines 528a of different interconnect layers 506-510 together.

The interconnect layers 506-510 may include a dielectric material 526 disposed between the interconnect structures 528, as shown in FIG. 5. In some embodiments, dielectric material 526 disposed between the interconnect structures 528 in different ones of the interconnect layers 506-510 may have different compositions; in other embodiments, the composition of the dielectric material 526 between different interconnect layers 506-510 may be the same. The device layer 504 may include a dielectric material 526 disposed between the transistors 540 and a bottom layer of the metallization stack as well. The dielectric material 526 included in the device layer 504 may have a different composition than the dielectric material 526 included in the interconnect layers 506-510; in other embodiments, the composition of the dielectric material 526 in the device layer 504 may be the same as a dielectric material 526 included in any one of the interconnect layers 506-510.

A first interconnect layer 506 (referred to as Metal 1 or “M1”) may be formed directly on the device layer 504. In some embodiments, the first interconnect layer 506 may include lines 528a and/or vias 528b, as shown. The lines 528a of the first interconnect layer 506 may be coupled with contacts (e.g., the S/D contacts 524) of the device layer 504. The vias 528b of the first interconnect layer 506 may be coupled with the lines 528a of a second interconnect layer 508.

The second interconnect layer 508 (referred to as Metal 2 or “M2”) may be formed directly on the first interconnect layer 506. In some embodiments, the second interconnect layer 508 may include via 528b to couple the lines of the interconnect structures 528 of the second interconnect layer 508 with the lines 528a of a third interconnect layer 510. Although the lines 528a and the vias 528b are structurally delineated with a line within individual interconnect layers for the sake of clarity, the lines 528a and the vias 528b may be structurally and/or materially contiguous (e.g., simultaneously filled during a dual-damascene process) in some embodiments.

The third interconnect layer 510 (referred to as Metal 3 or “M3”) (and additional interconnect layers, as desired) may be formed in succession on the second interconnect layer 508 according to similar techniques and configurations described in connection with the second interconnect layer 508 or the first interconnect layer 506. In some embodiments, the interconnect layers that are “higher up” in the metallization stack 519 in the integrated circuit 500 (i.e., farther away from the device layer 504) may be thicker that the interconnect layers that are lower in the metallization stack 519, with lines 528a and vias 528b in the higher interconnect layers being thicker than those in the lower interconnect layers.

The integrated circuit 500 may include a solder resist material 534 (e.g., polyimide or similar material) and one or more conductive contacts 536 formed on the interconnect layers 506-510. In FIG. 5, the conductive contacts 536 are illustrated as taking the form of bond pads. The conductive contacts 536 may be electrically coupled with the interconnect structures 528 and configured to route the electrical signals of the transistor(s) 540 to external devices. For example, solder bonds may be formed on the one or more conductive contacts 536 to mechanically and/or electrically couple an integrated circuit die including the integrated circuit 500 with another component (e.g., a printed circuit board). The integrated circuit 500 may include additional or alternate structures to route the electrical signals from the interconnect layers 506-510; for example, the conductive contacts 536 may include other analogous features (e.g., posts) that route the electrical signals to external components.

In some embodiments in which the integrated circuit 500 is a double-sided die, the integrated circuit 500 may include another metallization stack (not shown) on the opposite side of the device layer(s) 504. This metallization stack may include multiple interconnect layers as discussed above with reference to the interconnect layers 506-510, to provide electrically conductive paths (e.g., including conductive lines and vias) between the device layer(s) 504 and additional conductive contacts (not shown) on the opposite side of the integrated circuit 500 from the conductive contacts 536.

In other embodiments in which the integrated circuit 500 is a double-sided die, the integrated circuit 500 may include one or more through-silicon vias (TSVs) through the die substrate 502; these TSVs may make contact with the device layer(s) 504, and may provide electrically conductive paths between the device layer(s) 504 and additional conductive contacts (not shown) on the opposite side of the integrated circuit 500 from the conductive contacts 536. In some embodiments, TSVs extending through the substrate can be used for routing power and ground signals from conductive contacts on the opposite side of the integrated circuit 500 from the conductive contacts 536 to the transistors 540 and any other components integrated into the die with the integrated circuit 500, and the metallization stack 519 can be used to route I/O signals from the conductive contacts 536 to transistors 540 and any other components integrated into the die with the integrated circuit 500.

Multiple integrated circuits 500 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

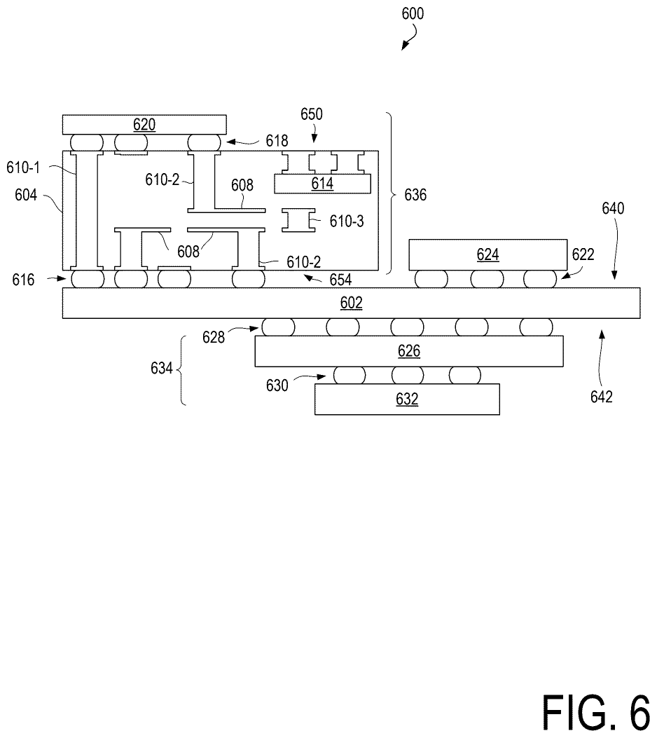

FIG. 6 is a cross-sectional side view of a microelectronic assembly 600 that may include any of the embodiments disclosed herein. The microelectronic assembly 600 includes multiple integrated circuit components disposed on a circuit board 602 (which may be a motherboard, system board, mainboard, etc.). The microelectronic assembly 600 may include components disposed on a first face 640 of the circuit board 602 and an opposing second face 642 of the circuit board 602; generally, components may be disposed on one or both faces 640 and 642.

In some embodiments, the circuit board 602 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 602. In other embodiments, the circuit board 602 may be a non-PCB substrate. The microelectronic assembly 600 illustrated in FIG. 6 includes a package-on-interposer structure 636 coupled to the first face 640 of the circuit board 602 by coupling components 616. The coupling components 616 may electrically and mechanically couple the package-on-interposer structure 636 to the circuit board 602, and may include solder balls (as shown in FIG. 6), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 636 may include an integrated circuit component 620 coupled to an interposer 604 by coupling components 618. The coupling components 618 may take any suitable form for the application, such as the forms discussed above with reference to the coupling components 616. Although a single integrated circuit component 620 is shown in FIG. 6, multiple integrated circuit components may be coupled to the interposer 604; indeed, additional interposers may be coupled to the interposer 604. The interposer 604 may provide an intervening substrate used to bridge the circuit board 602 and the integrated circuit component 620.

The integrated circuit component 620 may be a packaged or unpackaged integrated circuit component that includes one or more integrated circuit dies (e.g., the die 402 of FIG. 4, the integrated circuit 500 of FIG. 5) and/or one or more other suitable components.

The unpackaged integrated circuit component 620 comprises solder bumps attached to contacts on the die. The solder bumps allow the die to be directly attached to the interposer 604. In embodiments where the integrated circuit component 620 comprises multiple integrated circuit die, the dies can be of the same type (a homogeneous multi-die integrated circuit component) or of two or more different types (a heterogeneous multi-die integrated circuit component). In addition to comprising one or more processor units, the integrated circuit component 620 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate, or combinations thereof. A packaged multi-die integrated circuit component can be referred to as a multi-chip package (MCP) or multi-chip module (MCM).

The interposer 604 may spread connections to a wider pitch or reroute a connection to a different connection. For example, the interposer 604 may couple the integrated circuit component 620 to a set of ball grid array (BGA) conductive contacts of the coupling components 616 for coupling to the circuit board 602. In the embodiment illustrated in FIG. 6, the integrated circuit component 620 and the circuit board 602 are attached to opposing sides of the interposer 604; in other embodiments, the integrated circuit component 620 and the circuit board 602 may be attached to a same side of the interposer 604. In some embodiments, three or more components may be interconnected by way of the interposer 604.

In some embodiments, the interposer 604 may be formed as a PCB, including multiple metal layers separated from one another by layers of dielectric material and interconnected by electrically conductive vias. In some embodiments, the interposer 604 may be formed of an epoxy resin, a fiberglass-reinforced epoxy resin, an epoxy resin with inorganic fillers, a ceramic material, or a polymer material such as polyimide. In some embodiments, the interposer 604 may be formed of alternate rigid or flexible materials that may include the same materials described above for use in a semiconductor substrate, such as silicon, germanium, and other group III-V and group IV materials. The interposer 604 may include metal interconnects 608 and vias 610, including but not limited to through hole vias 610-1 (that extend from a first face 650 of the interposer 604 to a second face 654 of the interposer 604), blind vias 610-2 (that extend from the first or second faces 650 or 654 of the interposer 604 to an internal metal layer), and buried vias 610-3 (that connect internal metal layers).

In some embodiments, the interposer 604 can comprise a silicon interposer. Through-silicon vias (TSV) extending through the silicon interposer can connect connections on the first face of a silicon interposer to an opposing second face of the silicon interposer. In some embodiments, an interposer 604 comprising a silicon interposer can further comprise one or more routing layers to route connections on a first face of the interposer 604 to an opposing second face of the interposer 604.

The interposer 604 may further include embedded devices 614, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 604. The package-on-interposer structure 636 may take the form of any of the package-on-interposer structures known in the art.

The integrated circuit assembly 600 may include an integrated circuit component 624 coupled to the first face 640 of the circuit board 602 by coupling components 622. The coupling components 622 may take the form of any of the embodiments discussed above with reference to the coupling components 616, and the integrated circuit component 624 may take the form of any of the embodiments discussed above with reference to the integrated circuit component 620.

The integrated circuit assembly 600 illustrated in FIG. 6 includes a package-on-package structure 634 coupled to the second face 642 of the circuit board 602 by coupling components 628. The package-on-package structure 634 may include an integrated circuit component 626 and an integrated circuit component 632 coupled together by coupling components 630 such that the integrated circuit component 626 is disposed between the circuit board 602 and the integrated circuit component 632. The coupling components 628 and 630 may take the form of any of the embodiments of the coupling components 616 discussed above, and the integrated circuit components 626 and 632 may take the form of any of the embodiments of the integrated circuit component 620 discussed above. The package-on-package structure 634 may be configured in accordance with any of the package-on-package structures known in the art.

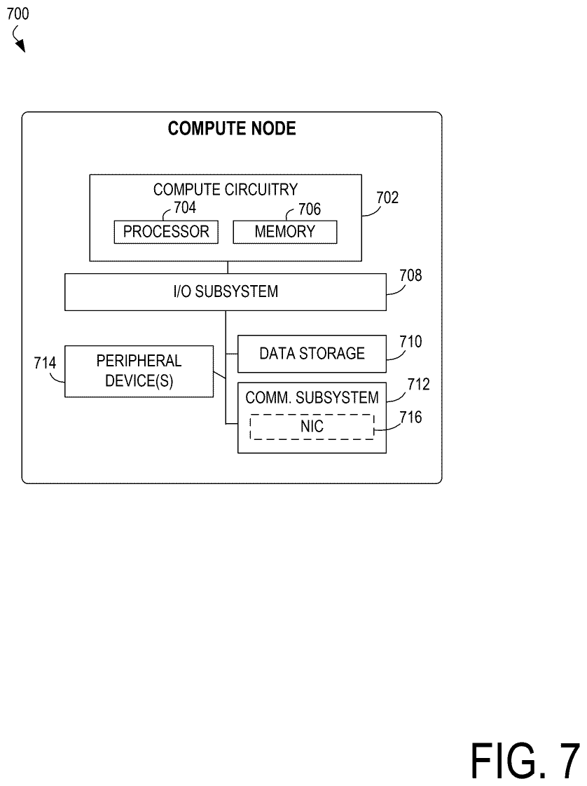

Disclosed embodiments may be implemented in a compute node. In the simplified example depicted in FIG. 7, a compute node 700 includes a compute engine (referred to herein as “compute circuitry”) 702, an input/output (I/O) subsystem 708, data storage 710, a communication circuitry subsystem 712, and, optionally, one or more peripheral devices 714. With respect to the present example, the compute node 700 or compute circuitry 702 may perform the operations and tasks attributed to the system 101. In other examples, respective compute nodes 700 may include other or additional components, such as those typically found in a computer (e.g., a display, peripheral devices, etc.). Additionally, in some examples, one or more of the illustrative components may be incorporated in, or otherwise form a portion of, another component.

In some examples, the compute node 700 may be embodied as a single device such as an integrated circuit, an embedded system, a field-programmable gate array (FPGA), a system-on-a-chip (SOC), or another integrated system or device. In the illustrative example, the compute node 700 includes or is embodied as a processor 704 and a memory 706. The processor 704 may be embodied as any type of processor capable of performing the functions described herein (e.g., executing compile functions and executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing, or managing server or data center hardware, managing service meshes, or collecting and distributing telemetry), outside of the CPU or general-purpose processing hardware. However, it will be understood that an xPU, a SOC, a CPU, and other variations of the processor 704 may work in coordination with each other to execute many types of operations and instructions within and on behalf of the compute node 700.

The memory 706 may be embodied as any type of volatile (e.g., dynamic random-access memory (DRAM), etc.) or non-volatile memory or data storage capable of performing the functions described herein. Volatile memory may be a storage medium that requires power to maintain the state of data stored by the medium. Non-limiting examples of volatile memory may include several types of random-access memory (RAM), such as DRAM or static random-access memory (SRAM). One type of DRAM that may be used in a memory module is synchronous dynamic random-access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication subsystem 712 may be embodied as any communication circuit, device, transceiver circuit, or collection thereof, capable of enabling communications over a network between the compute circuitry 702 and another computing device (e.g., an edge gateway of an implementing edge computing system).

The communication subsystem 712 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication subsystem 712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication subsystem 712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication subsystem 712 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication subsystem 712 may operate in accordance with other wireless protocols in other embodiments. The communication subsystem 712 may include an antenna to facilitate wireless communications and/or to receive other wireless communications (such as AM or FM radio transmissions).

In some embodiments, the communication subsystem 712 may manage wired communications, such as electrical, optical, or any other suitable communication protocols (e.g., IEEE 802.3 Ethernet standards). As noted above, the communication subsystem 712 may include multiple communication components. For instance, a first communication subsystem 712 may be dedicated to shorter-range wireless communications such as Wi-Fi or Bluetooth, and a second communication subsystem 712 may be dedicated to longer-range wireless communications such as global positioning system (GPS), EDGE, GPRS, CDMA, WiMAX, LTE, EV-DO, or others. In some embodiments, a first communication subsystem 712 may be dedicated to wireless communications, and a second communication subsystem 712 may be dedicated to wired communications.

The illustrative communication subsystem 712 includes an optional network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another computing device (e.g., an edge gateway node). In some examples, the NIC 720 may be embodied as part of a system-on-a-chip (SoC) that includes one or more processors or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a computing device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In other examples, the compute node 700 may be embodied as any type of device or collection of devices capable of performing various compute functions. Respective compute nodes 700 may be embodied as a type of device, appliance, computer, or other “thing” capable of communicating with other compute nodes that may be edge, networking, or endpoint components. For example, a compute node may be embodied as a personal computer, server, smartphone, a mobile computing device, a smart appliance, smart camera, an in-vehicle compute system (e.g., a navigation system), a weatherproof or weather-sealed computing appliance, a self-contained device within an outer case, shell, etc., or other device or system capable of performing the described functions.

While at least one embodiment has been presented in the foregoing detailed description, it should be appreciated that a vast number of variations exist. It should also be appreciated that the disclosed embodiments are only examples, and are not intended to limit the scope, applicability, or configuration of the disclosure in any way. Rather, the foregoing detailed description will provide those skilled in the art with a convenient road map for implementing the disclosed aspects of the present disclosure. Various changes can be made in the function and arrangement of elements without departing from the scope of the disclosure as set forth in the appended claims and the legal equivalents thereof.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

Additionally, theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

As used herein, a “computing system” or “compute device” refers to any of a variety of computing devices and includes systems comprising multiple discrete physical components. In some embodiments, the computing systems are located in laptop computer, a desktop computer, a data center, such as an enterprise data center (e.g., a data center owned and operated by a company and typically located on company premises), managed services data center (e.g., a data center managed by a third party on behalf of a company), a collocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

As used herein, the terms “processor unit,” “processing unit” or “processor” may refer to any device or portion of a device that processes electronic data from registers and/or memory to transform that electronic data into other electronic data that may be stored in registers and/or memory. A processor unit may be a system-on-a-chip (SOC), and/or include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

As used herein, phrases such as “embodiments,” “an aspect of the present disclosure,” “various aspects of the present disclosure,” “some aspects of the present disclosure,” and the like, indicate that some aspects of the present disclosure may have some, all, or none of the features described for other aspects of the present disclosure. “First,” “second,” “third,” and the like describe a common object and indicate different instances of like objects being referred to; unless specifically stated, they do not imply a given sequence, either temporally or spatially, in ranking, or any other manner. In accordance with patent application parlance, “connected” indicates elements that are in direct physical or electrical contact with each other and “coupled” indicates elements that co-operate or interact with each other, coupled elements may or may not be in direct physical or electrical contact. Furthermore, the terms “comprising,” “including,” “having,” and the like, are utilized synonymously to denote non-exclusive inclusions.

As used in this application and the claims, a list of items joined by the term “at least one of” can mean any combination of the listed terms. For example, the phrase “at least one of A, B and C” can mean A; B; C; A and B; A and C; B and C; or A, B, and C. Similarly, as used in this application and the claims, a list of items joined by the term “one or more of” can mean any combination of the listed terms. For example, the phrase “one or more of A, B and C” can mean A; B; C; A and B; A and C; B and C; or A, B, and C.

The following Examples pertain to additional aspects of the present disclosure of technologies disclosed herein.

Example 1 is a method comprising: accessing a semiconductor process emulation model having a plurality of model parameters; accessing process data for a foundry process node and process node revision; receiving error criteria and error value; generating, for at least one model parameter of the plurality of model parameters, a respective one or more alternate values; and wherein the respective one or more alternate values, when processed in the semiconductor process emulation model, generate a final predicted output; wherein the final predicted output has a target feature with a final measurement; wherein the final measurement, when evaluated with the error criteria, varies from a respective actual measurement by less than or equal to the error value.

Example 2 includes the subject matter of Example 1, wherein generating, for the at least one model parameter of the plurality of model parameters, the respective one or more alternate values, comprises: for a first model parameter of the plurality of model parameters: predicting a first intermediate predicted output that is based on the process data with the first model parameter equal to a first value; wherein the first intermediate predicted output has the target feature with a first measurement; wherein the first measurement, when evaluated with the error criteria, varies from the respective actual measurement by more than the error value; and predicting a second intermediate predicted output that is based on the process data with the first model parameter equal to a second value; wherein the second intermediate predicted output has the target feature with a second measurement; wherein the second measurement, when evaluated with the error criteria, varies from the respective actual measurement by more than the error value; and generating a third value for the first model parameter when both the first predicted measurement and the second predicted measurement vary from the respective actual measurement by more than the error value.

Example 3 includes the subject matter of Example 2, further comprising: calculating a gradient between the first measurement and the second measurement; wherein generating the third value for the first model parameter parameters is based on the gradient.

Example 4 includes the subject matter of Example 1 or 2, further comprising: generating, for individual model parameters of a remainder of the plurality of model parameters, a respective plurality of alternate values.

Example 5 includes the subject matter of Example 4, wherein generating, for the plurality of model parameters, the respective one or more alternate values further comprises: applying one or more methods from among enumerative search, parameter continuation, trajectory search, relaxation methods, branch-and-bound, random search, Bayesian search, adaptive stochastic search, evolutionary search, simulated annealing, and tabu search.

Example 6 includes the subject matter of Example 2, further comprising: generating a third intermediate predicted output based on the process data with the first model parameter equal to the third value.

Example 7 includes the subject matter of Example 1, further comprising: receiving a cost function; and calculating the final measurement using the cost function.

Example 8 includes the subject matter of Example 7, further comprising: determining a curvature of a profile of the target feature in the final predicted output; and determining the final measurement includes weighting the cost function based on the curvature of the profile.

Example 9 includes the subject matter of Example 7, further comprising: pixelating the final predicted output to create a pixelated predicted image; pixelating a source of the respective actual measurement to create a pixelated actual image; wherein the cost function is a material-sin-product (MSP), calculating the MSP as a count of pixels; determining a first material near the target feature in the pixelated predicted image and a second material near the target feature in the pixelated actual image; and the final measurement is a function of a number of pixels for which the first material and the second material are not equal.

Example 10 includes the subject matter of Example 9, further comprising: determining a curvature of the second material around the target; and weighting individual pixels based on the curvature of the second material.

Example 11 is one or more computer-readable storage media storing computer-executable instructions which when executed by a processor cause the processor to perform a method, the method comprising: accessing process data for a foundry process node; accessing a semiconductor process emulation model to operate on the process data, the semiconductor process emulation model having a plurality of model parameters; generating one or more alternate values of model parameters for a respective one or more model parameters of the plurality of model parameters; and wherein, responsive to a vector comprising the one or more alternate values of model parameters, the semiconductor process emulation model generates a final predicted output; wherein the final predicted output has a target feature with a final measurement that varies from a respective actual measurement by less than or equal to an error value.

Example 12 includes the subject matter of Example 11, wherein the method further comprises: accessing an error criteria; and wherein the final measurement, when evaluated with the error criteria, varies from the respective actual measurement by less than or equal to the error value.

Example 13 includes the subject matter of Example 12, wherein the method further comprises: for a first model parameter of the plurality of model parameters: predicting a first intermediate predicted output that is based on the process data with the first model parameter equal to a first value; wherein the first intermediate predicted output has the target feature with a first measurement; wherein the first measurement, when evaluated with the error criteria, varies from the respective actual measurement by more than the error value; and predicting a second intermediate predicted output that is based on the process data with the first model parameter equal to a second value; wherein the second intermediate predicted output has the target feature with a second measurement; wherein the second measurement, when evaluated with the error criteria, varies from the respective actual measurement by more than the error value; and generating a third value for the first model parameter when both the first predicted measurement and the second predicted measurement vary from the respective actual measurement by more than the error value.

Example 14 includes the subject matter of Example 13, wherein the method further comprises: calculating a gradient between the first measurement and the second measurement; wherein generating the third value for the first model parameter is based on the gradient.

Example 15 includes the subject matter of Example 11, wherein generating the one or more alternate values of the model parameters for the respective one or more model parameters of the plurality of model parameters further comprises: applying one or more methods from among enumerative search, parameter continuation, trajectory search, relaxation methods, branch-and-bound, random search, Bayesian search, adaptive stochastic search, evolutionary search, simulated annealing, and tabu search.

Example 16 includes the subject matter of any one of Examples 12-15, wherein the method further comprises: receiving a cost function; and determining the final measurement using the cost function.

Example 17 includes the subject matter of Example 16, wherein the method further comprises: determining a curvature of a profile of the target feature in the final predicted output; wherein determining the final measurement using the cost function is weighted based on the curvature of the profile.

Example 18 includes the subject matter of Example 17, wherein the method further comprises: pixelating the final predicted output to create a pixelated predicted image; pixelating a source of the respective actual measurement to create a pixelated actual image; wherein the cost function is a material-sin-product (MSP), calculating the MSP as a count of pixels; determining a first material near the target feature in the pixelated predicted image and a second material near the target feature in the pixelated actual image; and the final measurement is a function of a number of pixels for which the first material and the second material are not equal.

Example 19 is an apparatus, comprising: circuitry to: access process data for a foundry process node; receive a target feature; access characterization data for the foundry process node; access a semiconductor process emulation model to operate on the process data, the semiconductor process emulation model having a plurality of model parameters; and generate a vector comprising one or more alternate values for the plurality of model parameters; wherein, responsive to the vector comprising the one or more alternate values, the semiconductor process emulation model generates a final predicted output; wherein the final predicted output has a target feature with a final measurement that varies from a respective actual measurement by less than or equal to an error value.

Example 20 includes the subject matter of Example 19, wherein the circuitry is further to: access an error criteria; and wherein the final measurement, when evaluated with the error criteria, varies from the respective actual measurement by less than or equal to the error value.

What is claimed is:

1. A method comprising:
accessing a semiconductor process emulation model having a plurality of model parameters;
accessing process data for a foundry process node and process node revision;
receiving an error criteria and an error value;
generating, for at least one model parameter of the plurality of model parameters, a respective one or more alternate values; and
wherein the respective one or more alternate values, when processed in the semiconductor process emulation model, generate a final predicted output;
wherein the final predicted output has a target feature with a final measurement;
wherein the final measurement, when evaluated with the error criteria, varies from a respective actual measurement by less than or equal to the error value.

2. The method of claim 1, wherein generating, for the at least one model parameter of the plurality of model parameters, the respective one or more alternate values, comprises:
for a first model parameter of the plurality of model parameters:
predicting a first intermediate predicted output that is based on the process data with the first model parameter equal to a first value;
wherein the first intermediate predicted output has the target feature with a first measurement;
wherein the first measurement, when evaluated with the error criteria, varies from the respective actual measurement by more than the error value; and
predicting a second intermediate predicted output that is based on the process data with the first model parameter equal to a second value;
wherein the second intermediate predicted output has the target feature with a second measurement;
wherein the second measurement, when evaluated with the error criteria, varies from the respective actual measurement by more than the error value; and
generating a third value for the first model parameter when both the first predicted measurement and the second predicted measurement vary from the respective actual measurement by more than the error value.

3. The method of claim 2, further comprising:
calculating a gradient between the first measurement and the second measurement;
wherein generating the third value for the first model parameter parameters is based on the gradient.

4. The method of claim 2, further comprising:
generating, for individual model parameters of a remainder of the plurality of model parameters, a respective plurality of alternate values.

5. The method of claim 4, wherein generating, for the plurality of model parameters, the respective one or more alternate values further comprises:
applying one or more methods from among enumerative search, parameter continuation, trajectory search, relaxation methods, branch-and-bound, random search, Bayesian search, adaptive stochastic search, evolutionary search, simulated annealing, and tabu search.

6. The method of claim 2, further comprising:
generating a third intermediate predicted output based on the process data with the first model parameter equal to the third value.

7. The method of claim 1, further comprising:
receiving a cost function; and
calculating the final measurement using the cost function.

8. The method of claim 7, further comprising:
determining a curvature of a profile of the target feature in the final predicted output; and
determining the final measurement includes weighting the cost function based on the curvature of the profile.

9. The method of claim 7, further comprising:
pixelating the final predicted output to create a pixelated predicted image;
pixelating a source of the respective actual measurement to create a pixelated actual image;
wherein the cost function is a material-sin-product (MSP), calculating the MSP as a count of pixels;
determining a first material near the target feature in the pixelated predicted image and a second material near the target feature in the pixelated actual image; and
the final measurement is a function of a number of pixels for which the first material and the second material are not equal.

10. The method of claim 9, further comprising:
determining a curvature of the second material around the target feature; and
weighting individual pixels based on the curvature of the second material.

11. One or more computer-readable storage media storing computer-executable instructions which when executed by a processor cause the processor to perform a method, the method comprising:
accessing process data for a foundry process node;
accessing a semiconductor process emulation model to operate on the process data, the semiconductor process emulation model having a plurality of model parameters;
generating one or more alternate values of model parameters for a respective one or more model parameters of the plurality of model parameters; and
wherein, responsive to a vector comprising the one or more alternate values of model parameters, the semiconductor process emulation model generates a final predicted output;
wherein the final predicted output has a target feature with a final measurement that varies from a respective actual measurement by less than or equal to an error value.

12. The one or more computer-readable storage media of claim 11, wherein the method further comprises:
accessing an error criteria; and
wherein the final measurement, when evaluated with the error criteria, varies from the respective actual measurement by less than or equal to the error value.

13. The one or more computer-readable storage media of claim 12, wherein the method further comprises:
for a first model parameter of the plurality of model parameters:
predicting a first intermediate predicted output that is based on the process data with the first model parameter equal to a first value;
wherein the first intermediate predicted output has the target feature with a first measurement;
wherein the first measurement, when evaluated with the error criteria, varies from the respective actual measurement by more than the error value; and
predicting a second intermediate predicted output that is based on the process data with the first model parameter equal to a second value;
wherein the second intermediate predicted output has the target feature with a second measurement;
wherein the second measurement, when evaluated with the error criteria, varies from the respective actual measurement by more than the error value; and
generating a third value for the first model parameter when both the first predicted measurement and the second predicted measurement vary from the respective actual measurement by more than the error value.

14. The one or more computer-readable storage media of claim 13, wherein the method further comprises:
calculating a gradient between the first measurement and the second measurement;
wherein generating the third value for the first model parameter is based on the gradient.

15. The one or more computer-readable storage media of claim 11, wherein generating the one or more alternate values of the model parameters for the respective one or more model parameters of the plurality of model parameters further comprises:
applying one or more methods from among enumerative search, parameter continuation, trajectory search, relaxation methods, branch-and-bound, random search, Bayesian search, adaptive stochastic search, evolutionary search, simulated annealing, and tabu search.

16. The one or more computer-readable storage media of claim 12, wherein the method further comprises:
receiving a cost function; and
determining the final measurement using the cost function.

17. The one or more computer-readable storage media of claim 16, wherein the method further comprises:
determining a curvature of a profile of the target feature in the final predicted output;
wherein determining the final measurement using the cost function is weighted based on the curvature of the profile.

18. The one or more computer-readable storage media of claim 17, wherein the method further comprises:
pixelating the final predicted output to create a pixelated predicted image;
pixelating a source of the respective actual measurement to create a pixelated actual image;
wherein the cost function is a material-sin-product (MSP), calculating the MSP as a count of pixels;
determining a first material near the target feature in the pixelated predicted image and a second material near the target feature in the pixelated actual image; and
the final measurement is a function of a number of pixels for which the first material and the second material are not equal.

19. An apparatus, comprising:
circuitry to:
access process data for a foundry process node;
receive a target feature;
access characterization data for the foundry process node;
access a semiconductor process emulation model to operate on the process data, the semiconductor process emulation model having a plurality of model parameters; and
generate a vector comprising one or more alternate values for the plurality of model parameters;
wherein, responsive to the vector comprising the one or more alternate values, the semiconductor process emulation model generates a final predicted output;
wherein the final predicted output has a target feature with a final measurement that varies from a respective actual measurement by less than or equal to an error value.

20. The apparatus of claim 19, wherein the circuitry is further to:
access an error criteria; and
wherein the final measurement, when evaluated with the error criteria, varies from the respective actual measurement by less than or equal to the error value.
